(19) United States
(12) Patent Application Publication
(10) Pub. No.: US 2007/0022884 A1
(43) Pub. Date: Feb. 1, 2007

(54) Printing unit used in the tobacco-processing industry

(75) Inventor: Mathias Blau, Hamburg (DE)

Correspondence Address: GREENBLUM & BERNSTEIN, P.L.C., 1950 ROLAND CLARKE PLACE, RESTON, VA, 20191, US

(73) Assignee: HAUNI MASCHINEBAU AG, Hamburg (DE)

(21) Appl. No.: 11/485,314

(22) Filed: Jul. 13, 2006

(30) Foreign Application Priority Data
Jul. 27, 2005 (DE) 10 2005 035 701.6

(51) Int. Cl. B41F 7/02

(52) U.S. Cl. 101/217

(57) ABSTRACT

A printing unit of the tobacco-processing industry with a nozzle body for applying ink onto a transfer cylinder that is in operative contact with a transfer roller. The printing unit is further developed in that the transfer cylinder has an at least partially profiled cylinder surface. Furthermore, a machine used in the tobacco-processing industry, in particular a continuous rod-making machine, and a use of a transfer cylinder in a printing unit of the tobacco-processing industry is further provided.

### CROSS-REFERENCE TO RELATED APPLICATIONS

The present application claims priority under 35 U.S.C. §119 of German Patent Application No. 10 2005 035 701.6, filed on Jul. 27, 2005, the disclosure of which is expressly incorporated by reference herein in its entirety.

### BACKGROUND OF THE INVENTION

1. Field of the Invention

The invention relates to a printing unit used in the tobacco-processing industry with a nozzle body for applying ink onto a transfer cylinder that is in operative contact with a transfer roller. Furthermore, the invention relates to a continuous rod-making machine, and a use of a transfer cylinder in a printing unit of the tobacco-processing industry.

2. Discussion of Background Information

In the tobacco-processing industry, rod makers (rod-making machines) are used for producing continuous, wrapped rods. A wrapped rod refers to an endless filter rod or a tobacco rod formed of tobacco that is provided with a wrapping strip of paper, foil or the like.

A marking, lettering or logo or the like is printed on the wrapping strip of the tobacco rod or endless rod by a printing unit that is located in the rod maker. The color intensity of the marking is optically checked by the operator, whereby corrections to the color intensity are made manually. In particular, it has been found that numerous corrections need to be made during start-up of the rod maker, e.g., after a longer downtime.

In known printing units in continuous rod-making machines, the rollers and cylinders have a smooth structure on their surface. The printing ink for charging the stamp body is prepared in the printing unit, whereby the wrapping paper is provided with a corresponding imprint in the high-pressure process.

EP 1 415 805 A1, for example, describes a generic printing unit of a machine used in the tobacco-processing industry.

### SUMMARY OF THE INVENTION

The present invention provides a printing unit for a uniform and defined ink application for use in a rod maker used in the tobacco-processing industry.

The invention comprises a printing unit used in the tobacco-processing industry with a nozzle body for applying or inserting ink onto a transfer cylinder that is in operative contact with a transfer roller. The transfer cylinder has an at least partially profiled or structured cylinder surface.

According to the invention, the transfer cylinder is provided on its surface with a structure having irregularities or a profile pattern so that the ink applied to the transfer cylinder by the nozzle body is homogenized particularly quickly between the transfer cylinder and the transfer roller directly after the insertion of the ink. Through this, a particularly fast leveling and homogenization of the inserted ink is achieved within a few rotations during startup in the rolling mill. The rolling mill comprises a transfer cylinder, a transfer roller, a distributing cylinder and a distributing roller. In this manner, cigarettes with faulty imprint on the wrapping strip are clearly reduced.

The transfer roller and the transfer cylinder are in contact for the uniform distribution or milling of the inserted high-viscosity ink. The contact surface between the cylinder and the roller can be line-shaped or line-like. Moreover, a contact surface between the transfer roller and the transfer cylinder is also possible. Typically, an ink quantity between approximately 30 and 100 mg per 10,000 cigarettes is inserted via the nozzle body.

To form a structural grid or a profile pattern, the cylinder surface has recesses and/or elevations whereby, e.g., a rhombic knurled structure is provided on the cylinder surface.

In embodiments, the cylinder surface is uniformly profiled. Advantageously, the cylinder surface has a knurled pattern, whereby a rapid and good homogenization of a high-viscosity printing ink is achieved over the entire width of the cylinder surface.

In an embodiment, the height of the elevations or the depth of the recesses is between approximately 0.05 mm to 0.50 mm, and in particular between approximately 0.10 mm to 0.30 mm.

Furthermore, it is favorable when the transfer cylinder and/or the cylinder surface are made of metal, and in particular steel. Moreover, it is advantageous for the homogenization process of high-viscosity ink when the cylinder surface is coated, e.g., nitrated, such that a respectively desirable surface of the transfer cylinder can be achieved.

According to an embodiment of the printing unit, the nozzle body has a tapering nozzle head. The nozzle head is positioned or arranged in the convergence area of the transfer cylinder with the transfer roller. In particular, it should be understood that the convergence area is the intake area or area directly before a common contact line or a contact surface of the transfer cylinder and the transfer roller.

If the nozzle head has one, and in particular two, curved nozzle head side walls, the nozzle head can be arranged very close to the transfer roller and the transfer cylinder in the convergence area. In particular, the nozzle head side wall opposing the transfer roller is coaxial and concentric to the diameter of the transfer roller.

A good homogenization of the inserted viscous, in particular high-viscosity, printing ink in the range between approximately 10 to 30 Pas (Pascal seconds) is achieved when the spacing between the cylinder surface of the transfer cylinder and the nozzle head side wall opposing the cylinder surface with respect to the direction of rotation of the transfer cylinder decreases toward the contact area or convergence area between the transfer roller and the transfer cylinder. Through this, a tapering air gap curved in a wedge-shaped manner is formed between the nozzle head side wall and the transfer cylinder or the cylinder surface. In this manner, for example, a homogenous distribution of the ink quantity between the nozzle side wall and the transfer cylinder is achieved across the entire width of the cylinder surface in interaction with the uneven surface pattern or the knurled structure.

Furthermore, the nozzle head for inserting printing ink has at least one ink outlet opening. In embodiments, the at least one ink outlet opening is a slot on a nozzle head side wall. The width of the slot essentially corresponds to the width of the pressure plates or blocks on a stamp roller.

Moreover, the present invention includes a machine used in the tobacco-processing industry, in particular a continuous rod-making machine, which is equipped with a printing unit according to the invention described above. In the machine, a transfer cylinder in a printing unit, used in the tobacco-processing industry, has a nozzle body for inserting ink between a transfer roller and the transfer cylinder contacting the transfer roller. The transfer cylinder has an at least partially profiled or structured cylinder surface. The advantageous embodiments of the transfer cylinder result from the above description of the printing unit to which reference is likewise expressly made.

In aspects of the invention, a continuous rod-making machine comprises a transfer cylinder having at least a partially profiled cylinder surface and a transfer roller in operative contact with the transfer cylinder. A printing unit comprises a nozzle body for applying ink onto the transfer cylinder.

In aspects of the invention, a method of printing on a cigarette paper strip comprises dispensing printing ink from a nozzle body onto an at least partially profiled cylinder surface of a transfer cylinder in operative contact with a transfer roller.

In further embodiments, the printing ink is conveyed through an ink nozzle of the nozzle body. The printing ink is conveyed between the transfer roller and the transfer cylinder. The printing ink is transferred by the transfer roller to a distributing cylinder that conveys the printing ink to a distributing roller in contact with a stamp roller which prints images on a paper strip. The paper strip is pressed against the stamp roller by a pressure roller. The printing ink is homogenized between the transfer cylinder and the transfer roller directly after dispersing of the printing ink by way of the at least partially profiled cylinder surface. The homogenization of the printing ink is in the range between approximately 10 to 30 Pascal seconds.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a perspective view of a continuous rod-making machine according to the invention;

FIG. 2 shows a printing unit according to the invention;

FIG. 3 shows a perspective view of the printing unit shown in FIG. 2;

FIG. 4 shows a perspective view of a transfer cylinder according to the invention;

FIG. 5 shows a diagrammatic perspective view of a nozzle body according to the invention; and

FIG. 6 shows a side view of a tip of the nozzle body in a convergence area of the transfer cylinder and transfer roller according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice. In the following Figures the same or same type of elements or corresponding parts are labeled with the same reference numbers.

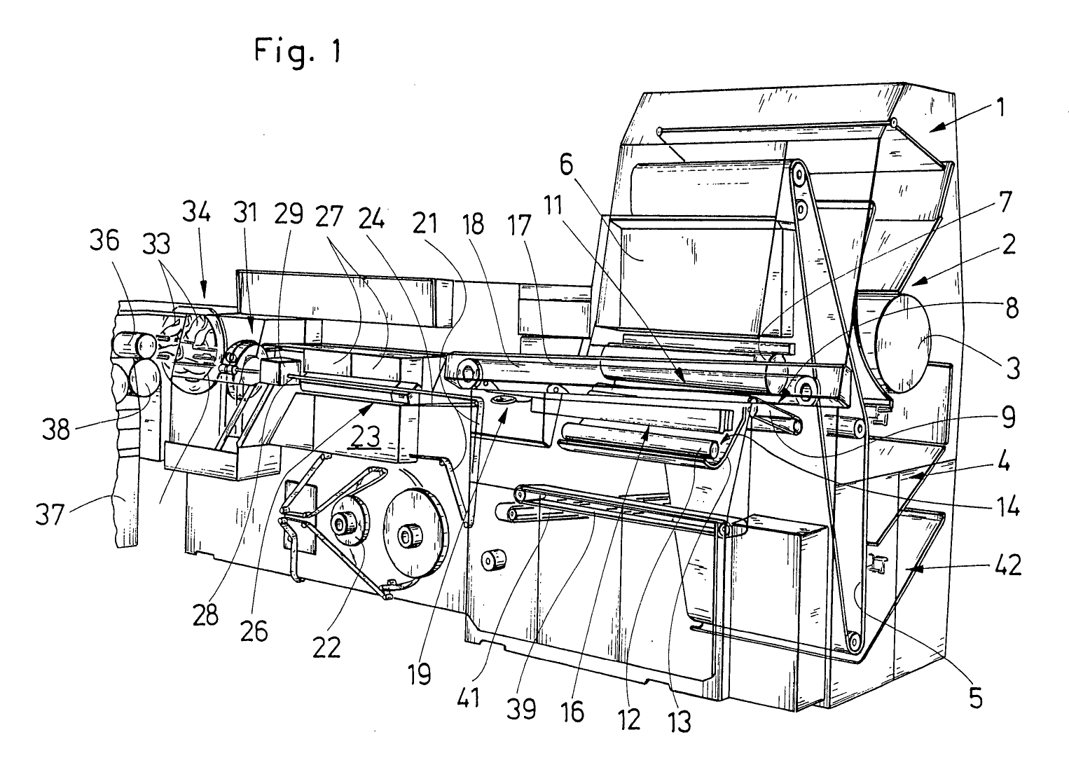

FIG. 1 shows a perspective view of a continuous rod-making machine according to the invention. In FIG. 1, a pre-distributor 2 is charged with tobacco in batches from a gate 1. A removal roller 3 of the pre-distributor 2 supplements a storage container 4 with tobacco in a controlled manner. A steep conveyor 5 removes tobacco from the storage container 4 and charges a retaining chute 6 in a controlled manner.

A carded roller 7 removes a uniform stream of tobacco from the retaining chute 6. The tobacco is shaken out of the carding of the carded roller 7 by a picker roller 8 and propelled onto an apron 9 circulating at a constant speed. A web of tobacco formed on the apron 9 is propelled into a sifting device 11 which essentially comprises a curtain of air through which the larger or heavier particles pass, while all the other tobacco particles are deflected by the air into a funnel 14 formed by a carded roller 12 and a wall 13. The tobacco is propelled by the carded roller 12 into a tobacco channel 16 against a rod conveyor 17, on which the tobacco is held by means of air suctioned into a vacuum chamber 18.

A leveling mechanism 19 removes excess tobacco from the tobacco rod. The tobacco is then laid onto a cigarette paper strip 21, guided synchronously. The cigarette paper strip 21 is drawn off a bobbin 22, guided through a printing unit 23 and laid on a driven garniture belt 24. The garniture belt 24 transports the tobacco rod and the cigarette paper strip 21 through a garniture 26 in which the cigarette paper strip 21 is folded around the tobacco rod so that one edge is protruding therefrom. The protruding edge is glued by a gluing device (not shown) in a known manner. Thereupon, the adhesive-coated seam is closed and dried by a tandem sealer 27.

A wrapped tobacco rod 28, formed as a material rod, passes through a rod-density measuring device 29, which controls the leveling mechanism 19. The wrapped tobacco rod 28 is cut into double-length cigarettes by a knife apparatus 31. The double-length cigarettes are transferred by a transfer device 34, provided with controlled arms 33, to a takeover drum 36 of a filter-tipping machine 37. The double length cigarette is cut into individual cigarettes on a cutting drum 38 by a circular knife.

Conveyor belts 39, 41 convey excess tobacco to a container 42 arranged before the storage container 4. The returned tobacco is removed from the container 42 by the steep conveyor 5.

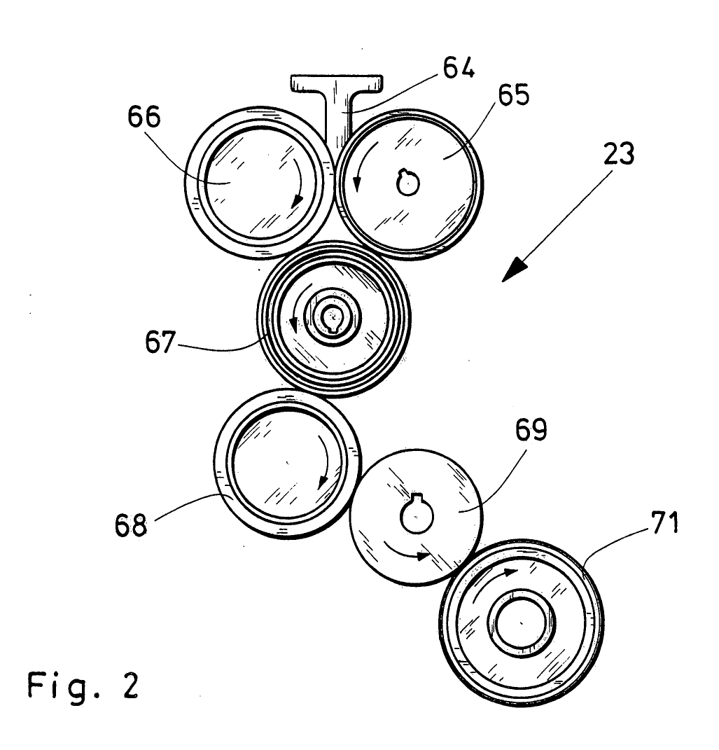

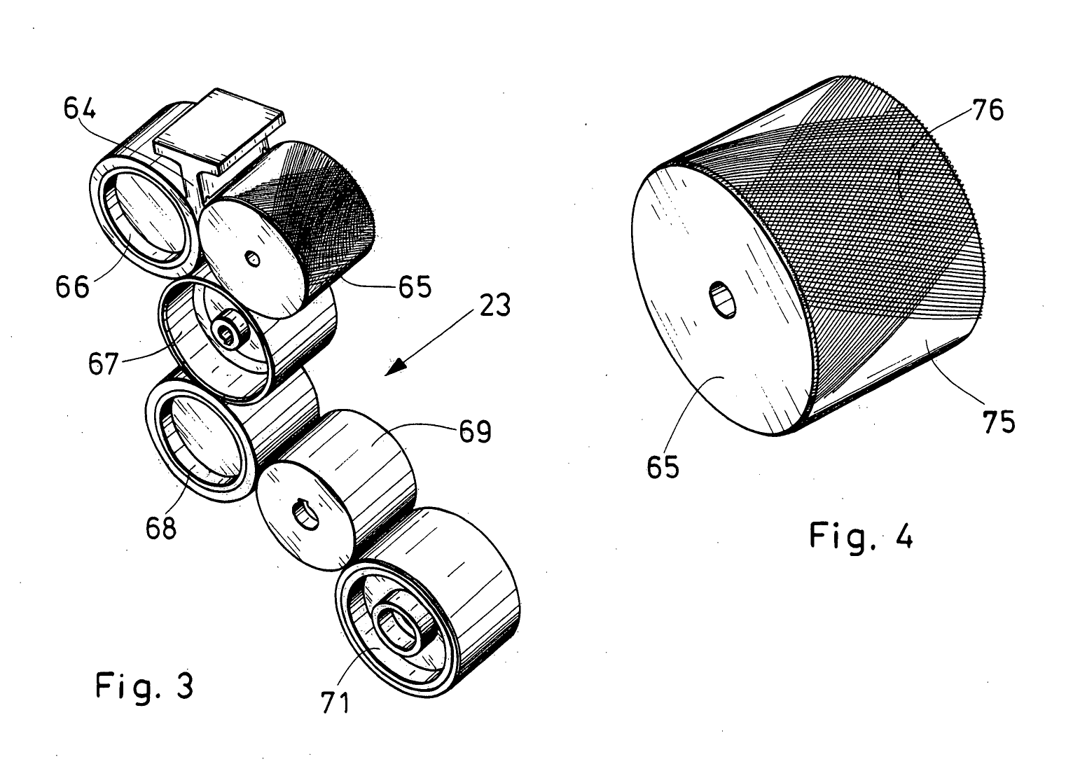

FIGS. 2 and 3 show a side view and perspective view, respectively, of a printing unit 23 according to the invention. In the printing unit 23, the printing ink for the ink application is prepared between a stamp body and cigarette paper strip. The cigarette paper strip is provided with a corresponding imprint in a high-pressure process. A pump (not shown) conveys the printing ink through a connecting block (not shown) into an ink nozzle 64. The ink nozzle 64 has a narrow outlet cross section which dispenses printing ink onto a transfer cylinder 65.

The ink quantity conveyed between a transfer roller 66 (e.g., made of rubber) and the transfer cylinder 65 (e.g., made of steel) is transferred by the transfer roller 66 to a distributing cylinder 67 that conveys the printing ink to a distributing roller 68. The distributing roller 68 contacts a stamp roller 69, by means of which the printed images are printed on the cigarette paper strips (see, FIG. 1, reference numeral 21). During the printing of the conveyed cigarette paper strip, the cigarette paper strip is pressed against the stamp roller 69 by a pressure roller 71. The stamp roller 69 imprints the cigarette paper strip with a company logo or with a brand name of a cigarette or the like. Moreover, a brush (not shown) is provided on the stamp roller 69 to clean the stamp roller 69 by removing excess printing ink from the stamp roller 69.

The transfer roller 66 and the distributing roller 68 have a rubberized smooth surface. The transfer cylinder 65 and the distributing cylinder 67 or their surfaces comprise, in embodiments, a metal, preferably steel.

FIG. 4 shows a perspective view of the transfer cylinder 65 according to the invention. According to the invention, the transfer cylinder 65 is provided on its surface with a structure having irregularities or a profile pattern so that the ink applied to the transfer cylinder by the nozzle body is homogenized quickly between the transfer cylinder and the transfer roller directly after the insertion of the ink. A good homogenization of the inserted viscous, in particular high-viscosity, printing ink is in the range between approximately 10 to 30 Pas (Pascal seconds).

In embodiment, the transfer cylinder 65 has on its circumferential area 75 a rhombic knurled structure 76. The knurled structure 76 has recesses and elevations so that the knurled structure 76 is uneven on the circumferential area 75. Of course, in embodiments, the knurled structure 76 can be uniform over the entire circumference of the circumferential area 75. In embodiments, the height of the elevations or the depth of the recesses is between approximately 0.05 mm to 0.50 mm, and in particular between approximately 0.10 mm to 0.30 mm.

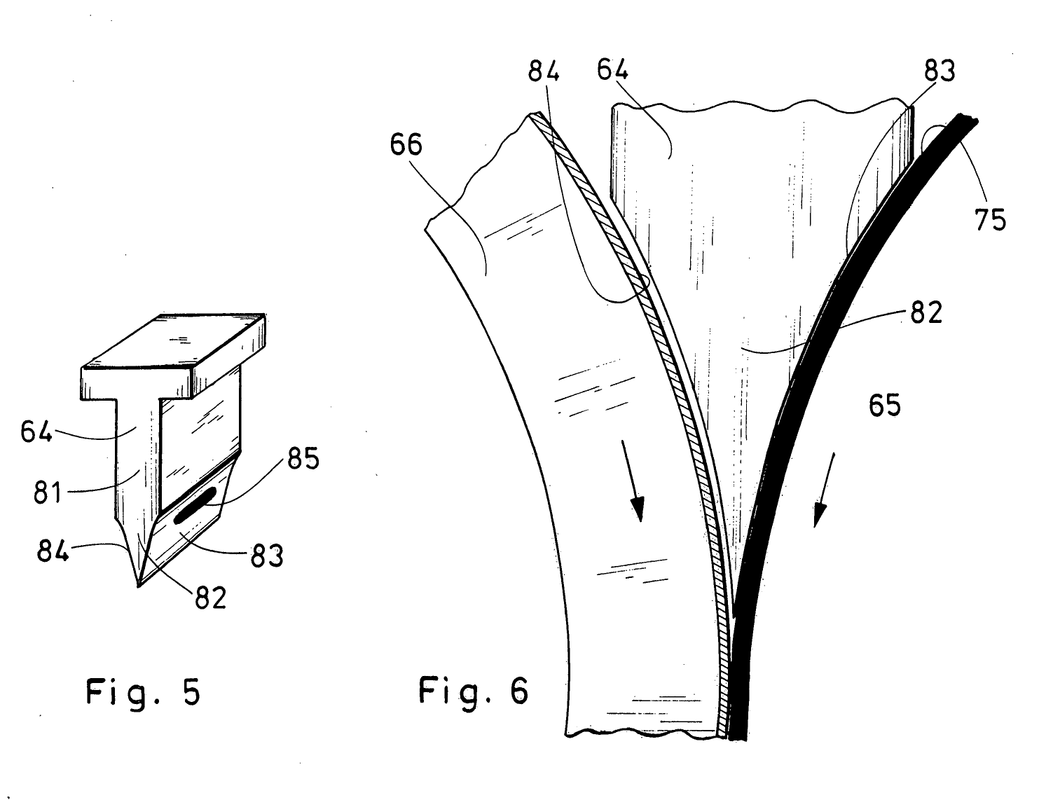

FIG. 5 shows a perspective view of the ink nozzle 64. The ink nozzle 64 has an elongated body shaft 81 on the lower end of which a tapering nozzle tip 82 is arranged. The nozzle tip 82 has on its side walls 83, 84 curved lateral surfaces. The curvature is adapted to the curvature radius of the surfaces of the transfer roller 66 or the transfer cylinder 65, arranged opposite the lateral surfaces 83, 84. Moreover, the lateral surface 83 assigned to the transfer cylinder 65 has a slot 85 from which the viscous printing ink is conveyed.

FIG. 6 shows an enlarged side view of the nozzle tip 82 of the ink nozzle 64 in the convergence area of the transfer cylinder 65 and the transfer roller 66. As shown, the spacing between the surface of the transfer roller 66 and the lateral surface 84 is virtually (e.g., substantially) constant, while on the other side the spacing between the lateral surface 83 and the surface 75 of the transfer cylinder 65 tapers towards the contact point of the transfer roller 66 and the transfer cylinder 65. Thus, as shown, a spacing between the cylinder surface of the transfer cylinder 65 and the nozzle head side wall 83 assigned to the cylinder surface with respect to the direction of rotation of the transfer cylinder 65 decreases toward the contact area or convergence area between the transfer roller 66 and the transfer cylinder 65.

A wedge-shaped curved gap is formed between the lateral surface 83 and the profiled circumferential area 75, whereby a particularly advantageous homogenization of the ink is achieved. As a result of the gap and the profiled circumferential area 75 of the transfer cylinder 65, a uniform distribution or homogenous squeezing of the ink between the uneven circumferential area 75 and the closely adjacent lateral surface 83 and ultimately a defined ink application of printed marks is rendered possible. In this manner, the high-viscosity printing ink is guided upon introduction into the printing unit 23.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMBERS

| | |
|---|---|
| 1 | Gate |
| 2 | Pre-distributor |
| 3 | Removal roll |
| 4 | Storage container |
| 5 | Steep conveyor |
| 6 | Retaining chute |
| 7 | Carded roller |
| 8 | Picker roller |
| 9 | Apron |
| 11 | Sifting device |
| 13 | Belt |
| 14 | Funnel |
| 16 | Tobacco channel |
| 17 | Rod conveyor |
| 18 | Vacuum chamber |
| 19 | Leveling means |
| 21 | Cigarette paper strip |
| 22 | Bobbin |
| 23 | Printing unit |
| 24 | Garniture belt |
| 26 | Garniture |
| 27 | Tandem sealer |
| 28 | Wrapped tobacco rod |
| 29 | Rod-density measuring device |
| 31 | Knife apparatus |
| 32 | Double-length cigarettes |
| 33 | Arms |
| 34 | Transfer device |
| 36 | Takeover drum |
| 37 | Filter tipping machine |
| 38 | Cutting drum |
| 39 | Conveyor belt |
| 41 | Conveyor belt |
| 42 | Container |
| 64 | Ink nozzle |
| 65 | Transfer cylinder |
| 66 | Transfer roller |
| 67 | Distributing cylinder |
| 68 | Distributing roller |
| 69 | Stamp roller |
| 71 | Pressure roller |
| 75 | Circumferential area |
| 76 | Knurled pattern |
| 81 | Body shaft |
| 82 | Nozzle tip |
| 83 | Lateral surface |
| 84 | Lateral surface |
| 85 | Slot |

1. A printing unit, comprising:
a nozzle body for applying ink onto a transfer cylinder in operative contact with a transfer roller, wherein the transfer cylinder has an at least partially profiled cylinder surface.

2. The printing unit according to claim 1, wherein the cylinder surface has at least one of recesses and elevations.

3. The printing unit according to claim 1, wherein the cylinder surface has a uniform profile.

4. The printing unit according to claim 1, wherein the cylinder surface has a knurled pattern.

5. The printing unit according to claim 2, wherein a height of the elevations or a depth of the recesses is between approximately 0.05 mm to 0.50 mm.

6. The printing unit according to claim 1, wherein at least one of the transfer cylinder and the cylinder surface comprises metal.

7. The printing unit according to claim 1, wherein the cylinder surface is coated.

8. The printing unit according to claim 1, wherein the nozzle body has a tapering nozzle head.

9. The printing unit according to claim 8, wherein the nozzle head is positioned in a convergence area of the transfer cylinder with the transfer roller.

10. The printing unit according to claim 8, wherein the nozzle head has at least one curved nozzle head side wall.

11. The printing unit according to claim 10, wherein the nozzle head side wall opposing the transfer roller is coaxial and concentric to a diameter of the transfer roller.

12. The printing unit according to claim 10, wherein a spacing between the cylinder surface of the transfer cylinder and the nozzle head side wall opposing the cylinder surface with respect to a direction of rotation of the transfer cylinder tapers towards a contact area between the transfer roller and the transfer cylinder.

13. The printing unit according to claim 1, wherein the nozzle head has at least one ink outlet opening.

14. The printing unit according to claim 13, wherein the at least one ink outlet opening is a slot.

15. The printing unit according to claim 5, wherein the height of the elevations or the depth of the recesses is between approximately 0.10 mm to 0.30 mm.

16. The printing unit according to claim 6, wherein at least one of the transfer cylinder and the cylinder surface comprises steel.

17. The printing unit according to claim 10, wherein the nozzle head has two curved nozzle head side walls.

18. The printing unit according to claim 1, wherein the at least partially profiled cylinder surface is a rhombic knurled structure.

19. The printing unit according to claim 7, wherein the cylinder surface is nitrated.

20. The printing unit according to claim 1, wherein a spacing between a surface of the transfer roller and a lateral surface of a nozzle head is substantially constant.

21. A continuous rod-making machine, comprising:
a transfer cylinder having at least a partially profiled cylinder surface;
a transfer roller in operative contact with the transfer cylinder; and
a printing unit comprising a nozzle body for applying ink onto the transfer cylinder.

22. A method of printing on a cigarette paper strip, comprising:
dispensing printing ink from a nozzle body onto an at least partially profiled cylinder surface of a transfer cylinder in operative contact with a transfer roller.

23. The method of claim 22, wherein the printing ink is conveyed through an ink nozzle of the nozzle body.

24. The method of claim 23, wherein the printing ink is conveyed between the transfer roller and the transfer cylinder having the an at least partially profiled cylinder surface of the transfer cylinder.

25. The method of claim 24, wherein the printing ink is transferred by the transfer roller to a distributing cylinder that conveys the printing ink to a distributing roller in contact with a stamp roller which prints images on a paper strip.

26. The method of claim 25, further comprising pressing the paper strip against the stamp roller by a pressure roller.

27. The method of claim 22, further comprising homogenizing the printed ink between the transfer cylinder and the transfer roller directly after dispersing of the printing ink by way of the at least partially profiled cylinder surface.

28. The method of claim 22, wherein a homogenization of the printing ink is in the range between approximately 10 to 30 Pascal seconds.
